(19) United States
(12) Patent Application Publication
(10) Pub. No.: US 2009/0110364 A1
(43) Pub. Date: Apr. 30, 2009

(54) REPRODUCTION APPARATUS AND REPRODUCTION METHOD

(76) Inventor: Manabu KURODA, Hyogo (JP)

Correspondence Address: MCDERMOTT WILL & EMERY LLP, 600 13TH STREET, NW, WASHINGTON, DC, 20005-3096, US

(21) Appl. No.: 12/177,536

(22) Filed: Jul. 22, 2008

(30) Foreign Application Priority Data
Oct. 29, 2007 (JP) 2007-280516

(51) Int. Cl. H04N 5/91

(52) U.S. Cl. 386/46

(57) ABSTRACT

In reproducing a stream containing video and audio, an audio decoder section decodes audio frames separated from the stream, and a video decoder section decodes video frames separated from the stream. Decoded audio data and video data are reproduced by an audio reproduction section and by a video reproduction section, while a synchronization section maintains temporal synchronization between the reproductions. When the stream has a seamless boundary at which a seamless connection has been made with priority given to the video frames, the audio decoder section skips m of the audio frames immediately after the seamless boundary without decoding the m frame or frames (where the number m is an integer equal to or higher than 1).

### CROSS REFERENCE TO RELATED APPLICATION

This application claims priority under 35 U.S.C. §119 on Patent Application No. 2007-280516 filed in Japan on Oct. 29, 2007, the entire contents of which are hereby incorporated by reference.

### BACKGROUND OF THE INVENTION

1. Field of the Invention

The present invention relates to a technique for reproducing a stream containing video and audio, and particularly relates to a technique for performing seamless reproduction.

2. Description of the Related Art

As a reproduction apparatus for performing stream reproduction, an image reproduction apparatus which seamlessly reproduces arbitrary frames in different files has been conventionally known (see Patent Document 1). In this image reproduction apparatus, two decoders are provided to allow for simultaneous decoding of the final GOP in a first (previous) file and the head GOP in a second (subsequent) file so that, following reproduction up to a specified frame in the first file, seamless reproduction is performed from a specified frame in the second file.

(Patent Document 1) Japanese Laid-Open Publication No. 2001-94938

For example, when, according to a BD (Blu-ray Disc) specification, a seamless connection is made with priority given to video frames, a problem occurs in that audio frames become misaligned at the seamless boundary, causing audio frames before and after the seamless boundary to overlap in time. In this case, if the audio frames are decoded as they are without considering the overlap and the resultant decoded data is output, the audio and the video are reproduced with different timing, resulting in a lip-sync error. In cases in which, to avoid such lip-sync errors, the overlap portions are superimposed and the output is then produced, achieving real-time reproduction processing requires that a plurality of audio decoders be prepared as in Patent Document 1 or an audio decoder having processing capability faster than that required in normal reproduction be provided, leading to an increase in the system costs. In addition, in order to reproduce the audio in synchronization with the video, audio frames before and after the seamless boundary must be stored and superimposed in advance, causing control to become complicated, which is undesirable.

Conventional techniques, including the above-described related technique, do not take these problems into account at all.

### SUMMARY OF THE INVENTION

It is therefore an object of the invention to simplify control in data reproduction operation when reproducing a stream which contains video and audio and in which a seamless connection has been made with priority given to video frames, without increasing system costs in the data reproduction operation.

According to the invention, in reproducing a stream containing video and audio, audio frames separated from the stream are decoded, video frames separated from the stream are decoded, and the decoded audio data and video data are reproduced while maintaining temporal synchronization between reproductions of the audio data and the video data. When the stream has a seamless boundary at which a seamless connection has been made with priority given to the video frames, m of the audio frames immediately after the seamless boundary are skipped without decoding the m frame or frames (where the number m is an integer equal to or higher than 1).

According to the invention, when a stream has a seamless boundary at which a seamless connection has been made with priority given to video frames, m of the audio frames immediately after the seamless boundary are skipped without decoding. Thus, one of the audio-frame overlap portions before and after the seamless boundary is not decoded. Hence, the amount of audio-data decoding processing at the seamless boundary does not exceed that in normal reproduction operation, eliminating the need for extra system cost and preventing the reproduction operation from becoming complicated to thereby allow simplification of control.

That is, according to the invention, in the case of a stream in which a seamless connection has been made with priority given to video frames, audio-data reproduction operation at the seamless boundary does not become complicated, thereby simplifying control in the data reproduction operation. In addition, it is not necessary to provide a plurality of decoders or a high-speed decoder to perform real-time processing.

### BRIEF DESCRIPTION OF THE DRAWINGS

FIG. 1 is a block diagram illustrating the configuration of a reproduction apparatus according to an embodiment of the invention.

FIG. 2 illustrates a stream containing a seamless boundary.

FIG. 3 illustrates operation in which a stream containing a seamless boundary is reproduced according to the embodiment of the invention.

FIG. 4 illustrates cases in which the number of overlap audio frames is different.

### DETAILED DESCRIPTION OF THE INVENTION

Hereinafter, embodiments of the invention will be described in detail with reference to the accompanying drawings.

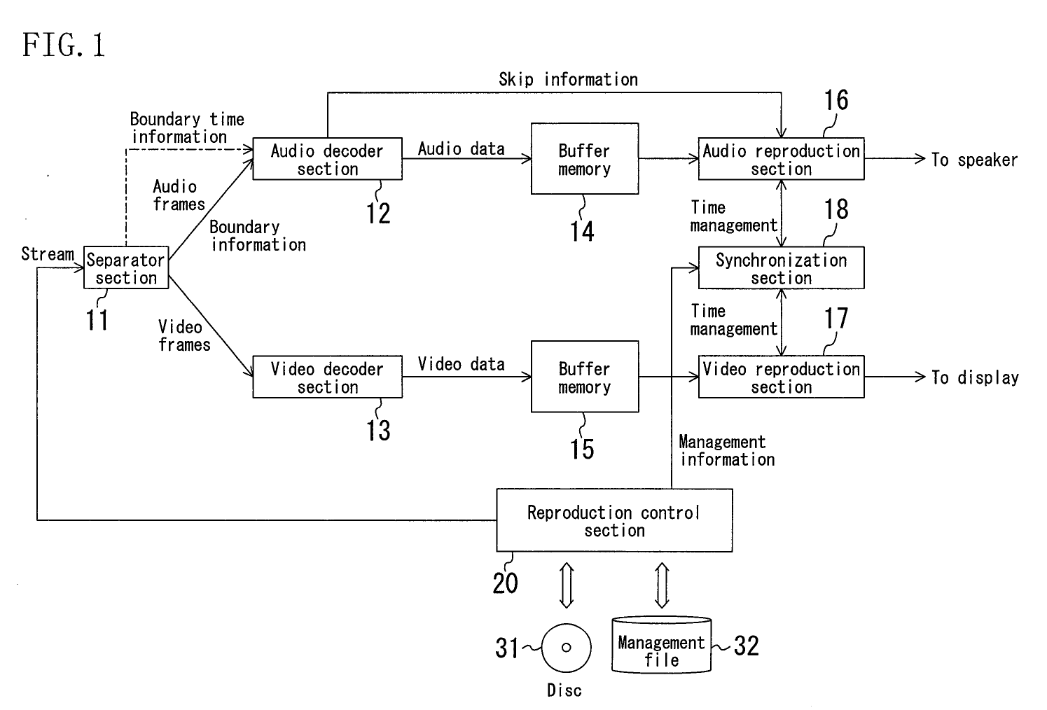

FIG. 1 is a block diagram illustrating the configuration of a reproduction apparatus according to an embodiment of the invention. In FIG. 1, the reference numeral 11 refers to a separator section which separates audio frames and video frames from a stream; 12 to an audio decoder section which decodes the audio frames separated by the separator section 11 from the stream; 13 to a video decoder section which decodes the video frames separated by the separator section 11 from the stream; 14 to a buffer memory which stores audio data output from the audio decoder section 12; 15 to a buffer memory which stores video data output from the video decoder section 13, 16 to an audio reproduction section which reproduces the audio data; 17 to a video reproduction section which reproduces the video data; and 18 to a synchronization section which maintains temporal synchronization between the data reproduction operations in the audio reproduction section 16 and in the video reproduction section 17. The buffer memories 14 and 15, the audio reproduction section 16, the video reproduction section 17, and the synchronization section 18 form a data reproduction section.

The reference numeral 20 denotes a reproduction control section which outputs the stream, while controlling the components stated above. The reproduction control section 20 reproduces the stream containing video and audio from a disc 31, for example. The reproduction control section 20 also refers to a management file 32 and provides read management information to the synchronization section 18 or the like.

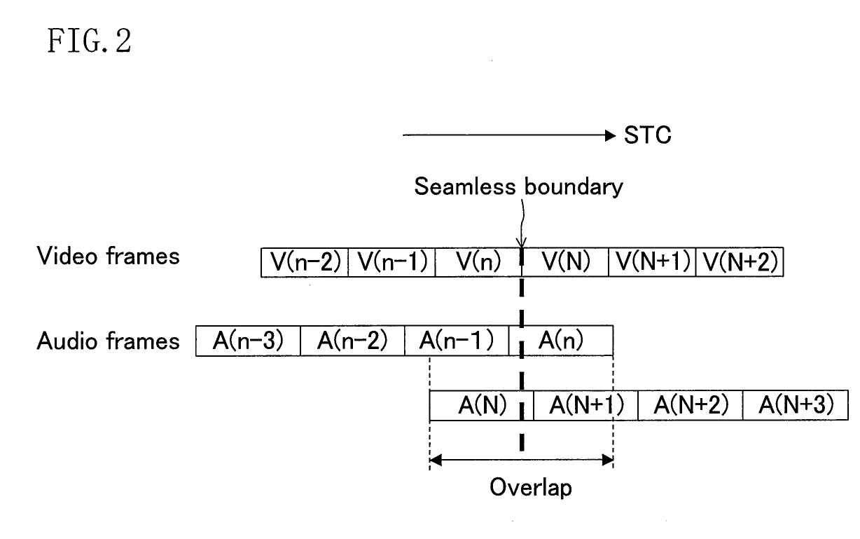

FIG. 2 illustrates an example of video frames and audio frames containing a seamless boundary. In FIG. 2, a seamless connection (CC=5) according to the BD specifications is illustrated as an example of specifications with which this embodiment complies. The abscissa represents the STC (System Time Clock).

The seamless boundary shown in FIG. 2 occurs due to editing, due to a temporary suspension during recording, or the like. In this embodiment, it is assumed that, at the seamless boundary, the seamless connection has been made with priority given to the video frames. In this case, a misalignment occurs in the audio frames before and after the seamless boundary. According to the BD specifications, the final audio frame (A(n)) in a transport stream before the seamless boundary and the initial audio frame (A(N)) in a transport stream after the seamless boundary contain the time of the seamless boundary in the video frames. Thus, a maximum of two audio frames overlap at the seamless boundary. However, no gap is generated.

In a case where a stream has a seamless boundary such as shown in FIG. 2, if audio frames are decoded as they are, complicated processing for synchronization control and the like will be necessary in the data reproduction. Therefore, in this embodiment, in order to simplify the data reproduction operation, the two audio frames immediately after the seamless boundary are skipped without decoding. This prevents the following data reproduction operation from becoming complicated.

Operation of the apparatus shown in FIG. 1 will be described. The audio decoder section 12 decodes audio frames separated by the separator section 11 from a stream, while the video decoder section 13 decodes video frames separated by the separator section 11 from the stream. The audio data decoded by the audio decoder section 12 is temporarily stored in the buffer memory 14 and then reproduced by the audio reproduction section 16. The video data decoded by the video decoder section 13 is temporarily stored in the buffer memory 15 and then reproduced by the video reproduction section 17. The synchronization section 18 issues an STC, thereby achieving temporal synchronization between the reproduction operations in the audio reproduction section 16 and in the video reproduction section 17. In this temporal synchronization, PTSs (Presentation Time Stamps) contained in the audio data and in the video data are used.

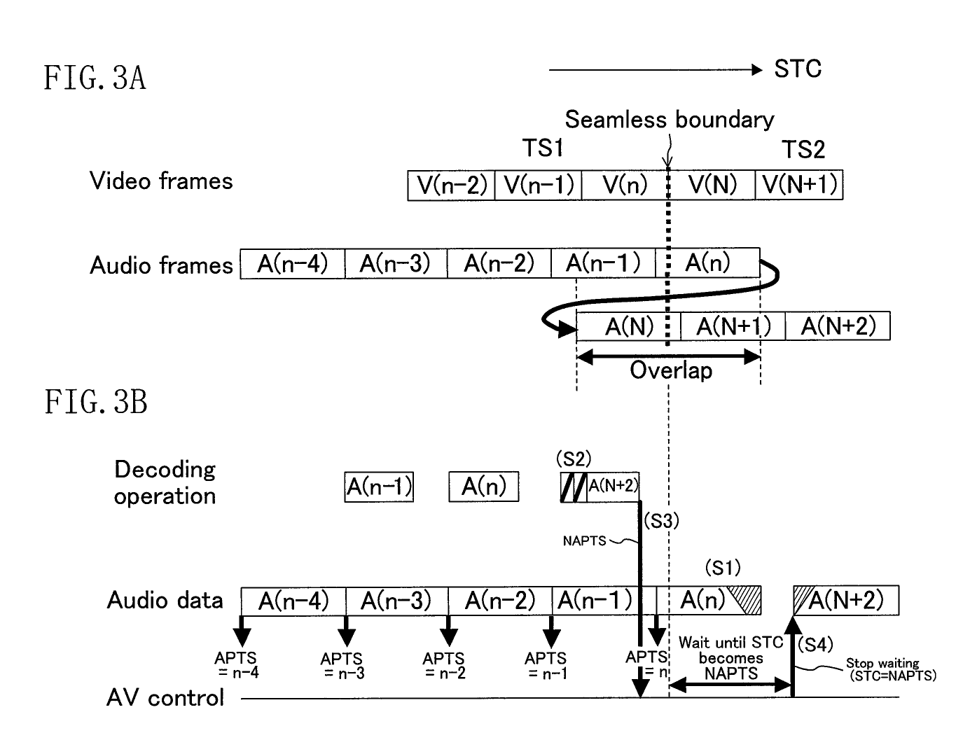

When a stream has a seamless boundary at which a seamless connection has been made with priority given to video frames as shown in FIG. 3A, the apparatus shown in FIG. 1 operates as shown in FIG. 3B. First, the audio reproduction section 16 mutes audio data decoded from the final audio frame (A(n)) in a transport stream TS1 before the seamless boundary (S1). At this time, it is desirable to fade-out the sound, that is, to gradually lower the sound level. The final time of the audio data before the seamless boundary is predictable based on management information received by the synchronization section 18 from the reproduction control section 20. The audio reproduction section 16 starts the muting sufficiently ahead of the predicted final time.

The audio decoder section 12 detects the seamless boundary from boundary information transmitted together with the audio frames. This boundary information is accomplished by, e.g., a flag embedded in the final audio frame in the transport stream before the seamless boundary. The audio decoder section 12 skips two audio frames immediately after the detected seamless boundary without decoding these two audio frames (S2). Then, the audio decoder section 12 decodes the third audio frame A(N+2), and upon the completion of the decoding, the audio decoder section 12 transmits NAPTS (i.e., a PTS in the audio frame A(N+2)) as skip information to the audio reproduction section 16 (S3).

The synchronization section 18 performs control to achieve synchronization at the seamless boundary. The audio reproduction section 16 delays starting the reproduction operation until the STC becomes the NAPTS. When the STC becomes the NAPTS, the audio reproduction section 16 releases the delay and again starts the data reproduction for the audio data decoded from the audio frame A(N+2) (S4). At this time, it is desirable to fade-in the sound, that is, to gradually increase the sound level.

The foregoing operation eliminates the need for complicated control in the data reproduction, even if the stream has the seamless boundary at which the seamless connection has been made with priority given to the video frames. Although the number of audio frames to be skipped is two in this embodiment, the invention is not limited to this. For example, if a maximum number of overlap audio frames at the seamless boundary is m (m is an integer equal to or higher than 1), m audio frame or frames may be skipped.

(Modified Example)

In the foregoing embodiment, the number m of audio frames to be skipped is a fixed value, but the number m may be variable. A description will be made of this case.

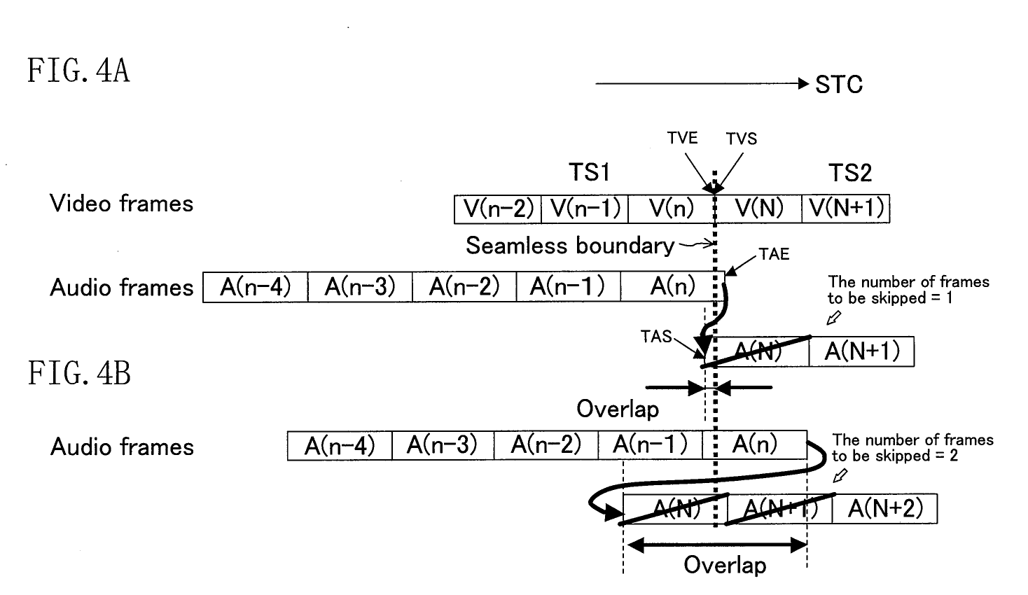

For example, in the case of the aforementioned BD specifications, the number of overlap audio frames is one in some cases as shown in FIG. 4A, and two in other cases as shown in FIG. 4B. If the number of audio frames to be skipped is fixed at two, the audio frame skipping is excessively performed in the case of FIG. 4A, causing the audio data to be deleted unnecessarily, which may only lead to an increase in the audio muting time.

In view of this, in this modified example, the number of audio frames to be skipped is calculated each time. Specifically, time information on times of video frames and audio frames before and after a seamless boundary, i.e., boundary time information, is obtained, and the number m of audio frames to be skipped is calculated from the boundary time information. For example, the number m is calculated by the following equation where TVE and TAE are the final times of the video and audio frames, respectively, in the transport stream TS1 before the seamless boundary, and TVS and TAS are information on the start of the video and audio frames, respectively, in the transport stream TS2 after the seamless boundary.

m=RUP {((TAE−TVE)−(TAS−TVS))/frame length}

(in which RUP { } is an expression indicating a round-up operation).

By this calculation, m=1 in the case of FIG. 4A, and m=2 in the case of FIG. 4B. Accordingly, the number m of audio frames to be skipped is set to an appropriate value in accordance with the audio frame overlap state.

In this case, in the apparatus configuration shown in FIG. 1, the audio decoder section 12 obtains TVE, TVS, TAE, and TAS as the boundary time information from the separator section 11, for example. The audio decoder section 12 does not necessarily have to obtain the boundary time information from the separator section 11, but may receive the boundary time information directly from the reproduction control section 20, for example. And the number m of audio frames to be skipped is calculated by the above equation, for example.

Furthermore, particularly in the case of real-time reproduction processing, in a system in which audio decoding processing is performed on one of a plurality of tasks on a single processor, a scheme is often adopted in which the audio decoding processing is performed in advance and the decoded audio data is stored in an audio buffer so as to accommodate a delay in response caused by task scheduling. In such a case, it is sometimes necessary to perform the audio decoding processing and determine the skip number m without waiting for video-frame decoding/outputting processing. On a transport stream, in particular, audio and video of the same time are not encoded in the same stream location, and hence there is no guarantee that results of the video decoding are obtained at the time of the audio decoding.

It is thus desirable that the reproduction control section 20 obtain in advance information stored beforehand separately from the transport streams and instruct the audio decoder section 12. In that case, assuming that the above-described TAE and TAS are obtainable, the audio decoder section 12 preferably obtains only TVE and TVS in advance. That is, TVE and TVS that are the time information on the times in the video at the seamless boundary are preferably stored in advance separately from the stream.

Moreover, after the completion of the reproduction of part of the audio before the seamless boundary, the audio reproduction section 16 must temporarily suspend the audio output as shown in FIG. 3B so as to achieve lip-sync between the audio output and the video output after the seamless boundary is passed. In this case, if, due to the system configuration, it is not easy to obtain the reproduction state in the video reproduction section 17 from the audio reproduction section 16 or if precise lip-sync control cannot be performed because time is required to obtain the reproduction state, then it is difficult for the audio reproduction section 16 to perform synchronization processing for the lip sync. Therefore, the audio reproduction section 16 obtains in advance TVE and TVS, which are the time information on the times in the video at the seamless boundary, from the reproduction control section 20, and calculates a period of time G, in which the audit output is temporarily suspended, by the following equation, for example.

G=m×frame length−{(TAE−TVE)−(TAS−TVS)}

This enables the audio reproduction section 16 to maintain lip sync before and after the seamless boundary without operating in conjunction with the video reproduction section 17.

The other operation is performed in the same manner as described in the embodiment set forth above, and description thereof will be thus omitted herein.

In this modified example, part or all of the boundary time information might sometimes be missing and unobtainable. In such a case, the number m of audio frames to be skipped may be set to a predetermined fixed value, for example, 2, and then the operation may be performed.

In the embodiment described above, the stream data is composed of transport streams, but may be stream data in other form, such as a program stream. Furthermore, the same processing is also applicable to cases in which video and audio are each independent stream data containing a seamless connection, and each stream data is reproduced.

The invention, which enables simplification of control in data reproduction operation when reproducing a stream in which a seamless connection has been made with priority given to video frames, is applicable to achieving, for example, a reproduction apparatus capable of seamless reproduction with a simple configuration without adding extra resources.

What is claimed is:

1. A reproduction apparatus for reproducing a stream containing video and audio, comprising:
an audio decoder section for decoding audio frames separated from the stream;
a video decoder section for decoding video frames separated from the stream; and
a data reproduction section for reproducing audio data decoded by the audio decoder section and video data decoded by the video decoder section, while maintaining temporal synchronization between reproductions of the audio data and the video data,
wherein when the stream has a seamless boundary at which a seamless connection has been made with priority given to the video frames, the audio decoder section skips m of the audio frames immediately after the seamless boundary without decoding the m frame or frames (where the number m is an integer equal to or higher than 1).

2. The reproduction apparatus of claim 1, wherein the number m is a fixed value.

3. The reproduction apparatus of claim 2, wherein the number m is 2.

4. The reproduction apparatus of claim 1, wherein the audio decoder section receives time information on times of video frames and audio frames before and after the seamless boundary and calculates the number m from the time information.

5. The reproduction apparatus of claim 4, wherein
m=RUP {((TAE−TVE)−(TAS−TVS))/frame length}
(in which RUP{ } is an expression indicating a round-up operation)
where TVE and TAE are a video frame final time and an audio frame final time, respectively, before the seamless boundary, and TVS and TAS are a video frame starting time and an audio frame starting time, respectively, after the seamless boundary.

6. The reproduction apparatus of claim 5, wherein the times TVE and TVS are stored in advance separately from the stream.

7. The reproduction apparatus of claim 6, wherein, after completion of the reproduction of part of the audio before the seamless boundary, the data reproduction section temporarily suspends output of the audio during a period of time G calculated from the times TVE and TVS stored in advance and from the times TAE and TAS.

8. The reproduction apparatus of claim 7, wherein G=m×frame length−{(TAE−TVE)−(TAS−TVS)}.

9. The reproduction apparatus of claim 4, wherein when at least part of the time information is missing, the audio decoder section sets the number m to a predetermined fixed value.

10. The reproduction apparatus of claim 1, wherein when the data reproduction section reproduces audio data decoded from a final audio frame in the stream before the seamless boundary, the data reproduction section gradually lowers sound level.

11. The reproduction apparatus of claim 1, wherein when the data reproduction section reproduces audio data decoded from an audio frame following the frame or frames skipped by the audio decoder section, the data reproduction section gradually increases sound level.

12. A method for reproducing a stream containing video and audio, comprising:
an audio decode step of decoding audio frames separated from the stream;
a video decode step of decoding video frames separated from the stream; and
a data reproduction step of reproducing decoded audio data and video data, while maintaining temporal synchronization between reproductions of the audio data and the video data,
wherein when the stream has a seamless boundary at which a seamless connection has been made with priority given to the video frames, the audio decode step includes the sub-step of skipping m of the audio frames immediately after the seamless boundary (where the number m is an integer equal to or higher than 1).
